(19) United States
(12) Patent Application Publication
(10) Pub. No.: US 2026/0211981 A1
(43) Pub. Date: Jul. 23, 2026

(54) TERMINAL-CENTRIC BEI DOMAIN-BASEPOINT BINDING, TIME-RING ACCOUNTING, PROOF-BUNDLED BEIMINT MINTING OF TIME CURRENCY AND BEI CURRENCY, AND OPTIONAL EXCHANGE/INDEX/PEG CONVERSION

(71) Applicant: FURONG BEI, SAN GABRIEL, CA (US)

(72) Inventor: FURONG BEI, SAN GABRIEL, CA (US)

(21) Appl. No.: 19/445,659

(22) Filed: Jan. 12, 2026

Related U.S. Application Data
(63) Continuation-in-part of application No. 19/315,561, filed on Aug. 31, 2025.
(63) Continuation-in-part of application No. 19/056,745, filed on Feb. 19, 2025.
(63) Continuation-in-part of application No. 19/192,322, filed on Apr. 28, 2025.
(63) Continuation-in-part of application No. 19/196,039, filed on May 1, 2025.
(63) Continuation-in-part of application No. 19/177,509, filed on Apr. 12, 2025.
(63) Continuation-in-part of application No. 19/186,359, filed on Apr. 22, 2025.
(63) Continuation-in-part of application No. 19/187,223, filed on Apr. 23, 2025.
(63) Continuation-in-part of application No. 19/072,412, filed on Mar. 6, 2025.
(63) Continuation-in-part of application No. 19/096,717, filed on Apr. 1, 2025.
(63) Continuation-in-part of application No. 19/083,357, filed on Mar. 18, 2025.
(63) Continuation-in-part of application No. 19/074,326, filed on Mar. 8, 2025, now abandoned.
(63) Continuation-in-part of application No. 19/094,730, filed on Mar. 28, 2025.
(63) Continuation-in-part of application No. 19/067,732, filed on Feb. 28, 2025.
(63) Continuation-in-part of application No. 19/067,845, filed on Mar. 1, 2025.
(63) Continuation-in-part of application No. 19/076,910, filed on Mar. 11, 2025.
(63) Continuation-in-part of application No. 19/079,378, filed on Mar. 13, 2025.
(63) Continuation-in-part of application No. 19/078,276, filed on Mar. 13, 2025.
(63) Continuation-in-part of application No. 19/080,825, filed on Mar. 15, 2025.
(63) Continuation-in-part of application No. 19/085,925, filed on Mar. 20, 2025, now abandoned.
(63) Continuation-in-part of application No. 19/084,806, filed on Mar. 20, 2025.
(63) Continuation-in-part of application No. 19/098,985, filed on Apr. 3, 2025.
(60) Provisional application No. 63/769,143, filed on Mar. 9, 2025.
(60) Provisional application No. 63/772,633, filed on Mar. 16, 2025.

(51) Int. Cl. G06F 21/10; G06F 21/64

(52) U.S. Cl. CPC G06F 21/1011; G06F 21/64

(57) ABSTRACT

A terminal-centric system binds terminals to a domain basepoint and access channel under a deed chain, orchestrates multi-terminal sessions, and anchors event chains to a time ring with linked minute/hour/day/week/month/year slices. A minimum-disclosure proof bundle is formed from evidence digests, device/role attestations, and an authorization signature. An anti-double-counting module computes validated time-slice coverage by unioning activity intervals and applying a focus-window rule. BEIMINT mints TIME CURRENCY from validated slice coverage and mints BEI CURRENCY from behavior-weighted proofs with risk controls and delayed settlement. A governance stack supports dispute callback, bounded and layered rollback, and clawback. Minted outputs may be listed via exchange interfaces, aggregated into a BEI Index, and converted to pegged units and an anchor unit.

### CROSS-REFERENCE TO RELATED APPLICATIONS

This application is a continuation-in-part of U.S. application Ser. No. 19/056,745, filed Feb. 19, 2025, and claims the benefit of that application under 35 U.S.C. § 120, as set forth in the Application Data Sheet (ADS).

Any domestic benefit claim under 35 U.S.C. § 120, 121, 365 (c), or 386 (c), and any claim for benefit under 35 U.S.C. § 119 (e), is made only to the extent expressly identified in the ADS. No other priority or domestic benefit is claimed.

For technical background and ecosystem context only (and not for priority or domestic benefit), the following U.S. applications are incorporated by reference to the extent permitted by 37 C.F.R. § 1.57 and to the extent not inconsistent with the present disclosure: U.S. application Ser. No. 19/059,110, filed Feb. 20, 2025; U.S. application Ser. No. 19/060,663, filed Feb. 22, 2025; U.S. application Ser. No. 19/067,732, filed Feb. 28, 2025; U.S. application Ser. No. 19/072,075, filed Mar. 6, 2025; U.S. application Ser. No. 19/073,574, filed Mar. 7, 2025; U.S. application Ser. No. 19/074,326, filed Mar. 8, 2025; U.S. application Ser. No. 19/084,790, filed Mar. 20, 2025; U.S. application Ser. No. 19/086,144, filed Mar. 21, 2025; U.S. application Ser. No. 19/094,730, filed Mar. 28, 2025; and U.S. application Ser. No. 19/374,710, filed Oct. 30, 2025.

### Defined Terms

(i) “BEI” or “Behavioral Economic Identity” refers to a subject-centric identity construct that represents, at least in part, verifiable behavioral, time, and event signals of a subject (e.g., a human, organization, device, or agent) as processed by one or more computing terminals under domain-context policy control. In non-limiting embodiments, BEI is represented by one or more identifiers, namespaces, attestations, and/or signed records that can be bound to a domain basepoint and access channel and gated by deed-chain authorization. Non-limiting access-channel examples include BEI.app.
(ii) “TIME CURRENCY” refers to time-denominated digital units minted and recorded by the system based on validated time-slice coverage anchored to a time ring. In non-limiting embodiments, TIME CURRENCY is computed from validated_duration derived from unioning activity intervals over one or more time_slice_id values, subject to anti-double-counting rules (e.g., a focus-window rule) and policy-pack constraints. TIME CURRENCY may be represented in minute/hour/day/week/month/year slices, transferable as mint-output records, and/or convertible via optional exchange/index/pegging interfaces. Non-limiting access-channel examples include TimeCurrency.com.
(iii) “BEI CURRENCY” refers to behavior-denominated digital units minted and recorded by the system based on behavior-weighted proofs associated with a BEI. In non-limiting embodiments, BEI CURRENCY is minted from a proof bundle comprising minimum-disclosure evidence (e.g., digests/commitments), device/role attestations, and an authorization signature, and is weighted or adjusted by a policy pack, risk-control rules, and settlement-window constraints. BEI CURRENCY may be transferable as mint-output records and may be aggregated, indexed, and/or converted to pegged units and/or an anchor unit via optional exchange and settlement mechanisms. Non-limiting access-channel examples include BECurrency.com.
(iv) “ATMS” or “ATMS.COM” refers to a non-limiting root basepoint/gateway embodiment that can serve as a population-scale routing, policy distribution, and coordination point for a global plurality of subject identities and terminals. In non-limiting embodiments, ATMS.COM enables deployments in which a large number of terminals (e.g., billions of trusted personal terminals and associated public-screen/gateway/IoT terminals) participate as: (a) event-verifying terminals producing proof bundles; (b) distributed mints executing minting of TIME CURRENCY and BEI CURRENCY; and (c) interoperable financial service endpoints supporting transfer, remittance, and settlement under deed-chain gating and bounded rollback governance. The foregoing population-scale description is illustrative only and does not limit the scope of the claims.

### TECHNICAL FIELD

The disclosure relates to distributed computing, secure multi-terminal interaction, and cryptographically verifiable event-chain generation. Embodiments include domain-basepoint binding of terminals via access channels and deed chains, time-granularity accounting (minute/hour/day/week/month/year), privacy-preserving proof bundling, policy-governed minting using BEIMINT (also referred to as BIMINT) of TIME CURRENCY and BEI CURRENCY, and governance procedures including dispute callback, bounded rollback, layered rollback, and clawback.

### BACKGROUND

Many digital workflows require trustworthy proofs of activity, identity, and outcomes across multiple devices (e.g., TV/public screens, mobile devices, PCs, IoT sensors, wireless/cellular terminals). Existing systems often fail to: (i) bind a shared-screen session to a trusted personal terminal and a specific identity under a clearly auditable authorization chain; (ii) prevent cross-terminal double counting of time; (iii) provide minimum-disclosure proofs suitable for privacy and compliance; and (iv) support controlled reversibility such as bounded rollback and clawback. These gaps prevent practical deployment of time-denominated and identity-denominated minting systems that must be simultaneously verifiable, privacy-preserving, and governable.

Conventional systems for event logging, digital payments, or token issuance often rely on application-layer attestations that can be replayed, duplicated across devices, or inconsistently scoped across domains, and may require disclosure of sensitive source data to achieve verification. Such approaches can leave unresolved technical problems including: (i) preventing double-counting of overlapping time or behavior intervals across heterogeneous terminals; (ii) enforcing executable authorization for issuance and transfer with auditable lineage and revocation; and (iii) providing fault isolation and dispute remediation without globally unwinding unrelated transactions. The embodiments described herein address these problems by combining terminal-bound challenge-response binding, time-ring slice accounting with anti-double-counting, minimum-disclosure proof bundles, deed-gated policy-controlled minting and settlement, and a governance state machine capable of bounded rollback and clawback within a defined scope.

### SUMMARY

A terminal-centric minting fabric is disclosed. Terminals are bound to a domain-basepoint namespace via access channels and a deed chain that represents ownership, authorization, delegation, and revocation. A session orchestration module merges multi-terminal events into an event chain, anchors the chain into a time ring with linked slices (minute/hour/day/week/month/year), forms a proof bundle comprising evidence digests and attestations under controlled disclosure, and mints TIME CURRENCY and BEI CURRENCY using a policy pack with risk controls and delayed settlement. An anti-double-counting module computes validated time-slice coverage. A governance stack supports dispute callback, bounded rollback (including by time slice and domain context), layered rollback, and clawback. In optional embodiments, minted units are listed via exchange interfaces, aggregated into an audit-ready BEI Index, and converted into pegged units (e.g., BEIUSD, BEICNY, BEIEUR) and/or an anchor unit.

### BRIEF DESCRIPTION OF THE DRAWINGS

FIG. 1 illustrates a terminal-centric BEI minting fabric (system overview), depicting multi-terminal binding, session orchestration, physical attestation, domain-context routing, time ring anchoring, proof attestation bundle generation, BEIMINT weighted minting with delayed-settlement control, bounded rollback governance, and an optional exchange/index/peg layer for listing, conversion, and transfer.

FIG. 2 illustrates a time ring namespace with linked minute/hour/day/week/month/year slices and bounded rollback granularity.

FIG. 3 illustrates a state-based minting and rollback layered state machine, including dispute callback (CALL BACK), bounded rollback (BEI FR2), layered rollback (BEI LOWER BACK), and clawback (BEI CLAW CALL).

FIG. 4 illustrates an optional BEIGX/SSX/CX exchange, a BEI Index engine, and a pegged-units layer (e.g., BEIUSD/BEICNY/BEIEUR) and/or an anchor unit.

FIG. 5 illustrates domain-context routing and policy packs across industries, needs, and resources, with an illustrative routing table.

FIG. 6 illustrates a terminal-basepoint binding record and deed-chain authorization, including delegation, transfer, revocation, expiration, and audit-pointer lineage.

FIG. 7 illustrates a mint input tuple and a time-slice coverage map for anti-double-counting, including focus-window validation and union-of-intervals processing.

FIGS. 8-13 illustrate non-limiting renderings of TIME CURRENCY units (minute/hour/day/week/month/year slices) and non-limiting insignia for BEI Nation, BEI Index, and BEIGX, optionally including illustrative Genesis 2026 labeling.

FIG. 14 illustrates non-limiting insignia for BEIGX, BEICX, and BEISX.

FIG. 15 illustrates a non-limiting BEI insignia.

FIG. 16 illustrates a non-limiting ATMS insignia.

All components, logos, insignia, renderings, labels, markings, and artistic elements in the figures are illustrative only and do not limit the scope of the claims.

### DETAILED DESCRIPTION

### 1. Definitions and Interpretation

Unless otherwise indicated, singular terms include plural embodiments. The terms “include” and “including” are non-limiting. “Domain basepoint” identifiers may be traditional domain names or functionally equivalent namespaces. Any labels, names, codes, or insignia shown in the figures are illustrative and do not limit the claims.

Defined Terms (Non-Limiting). As used herein: (i) “BEIDID” or “BIDID” refers to a BEI identity-root basepoint embodiment represented by a resolvable namespace identifier (e.g., a domain-basepoint, directory entry, and/or signed identifier token), and may be deployed, by way of non-limiting example, via BEIDID.COM and/or functionally equivalent namespace anchors; (ii) “BITerminal” refers to a trusted personal terminal and/or terminal stack configured for session binding, proof generation, and minting control as described herein; (iii) “ATMS” or “ATMS.COM” refers to a non-limiting root basepoint/gateway embodiment that can route or directory-link a plurality of basepoints/channels and support population-scale deployments (e.g., billions of subject identities and terminals) without expanding the rollback scope beyond a policy-defined (time_slice_id, basepoint/channel) boundary; (iv) “TIME CURRENCY” refers to time-denominated units minted from validated time-slice coverage; (v) “BEI CURRENCY” refers to behavior-weighted units minted from validated activity proofs under a policy pack; (vi) “BEIMINT” (also referred to as “BIMINT”) refers to the minting module that computes eligibility, applies policy weights/risk controls, and emits mint-output records; (vii) “DEED CHAIN” refers to an authorization lineage including grant, delegation, transfer, revocation, expiration, and audit pointers; and (viii) “BEIGX/BEISX/BEICX/SSX/CX” refer to non-limiting exchange and/or index interfaces for listing, transfer, and pegged conversion under policy-defined rules. These definitions are illustrative only and do not limit claim scope.

| Term | Definition (Non-Limiting) |
|---|---|
| BEI (Behavioral | A technical identity framework associating a |
| Economic | subject with verifiable event chains, |
| Identity) | contextual constraints, and policy-governed |
| | minting. |
| Terminal | A computing device participating in sessions, |
| | including TV/public screens, mobile phones, |
| | PCs, wearables, POS terminals, vehicles, IoT |
| | sensors, gateways, wireless/cellular devices, |
| | appliances, and robots. |
| Domain | A namespace anchor defining a context |
| Basepoint | boundary and routing scope. A basepoint may |
| | be represented by a domain name, subdomain, |
| | path-based identifier, or a functionally |
| | equivalent namespace identifier. |
| Access | A logical or named access pathway under a |
| Channel | basepoint used for terminal onboarding, |
| | routing, authorization, mint input admission, |
| | and output settlement. |
| Deed | A verifiable chain of authorization records for |
| Chain | basepoints/channels, supporting delegation, |
| | revocation, inheritance, leasing, and time- |
| | bounded grants. |
| Time Ring | A linked hierarchy of time slices, including |
| | minute, hour, day, week, month, and year |
| | slices, with slice-to-parent relationships. |
| TIME | A mint output denominated by validated time- |
| CURRENCY | slice coverage in the time ring and bound to |
| | corresponding slices, domain context, and |
| | proof bundles. |
| BEI | A mint output derived from behavior- |
| CURRENCY | weighted proofs associated with BEI event |
| | chains, including outcome attestations and |
| | role/institution attestations; in some |
| | embodiments, BEI CURRENCY is computed |
| | using TIME CURRENCY as a base measure. |
| BEIMINT | A minting engine that transforms validated |
| (BIMINT) | mint inputs into TIME CURRENCY and/or |
| | BEI CURRENCY under policy packs, risk |
| | controls, settlement windows, and rollback |
| | governance. |
| Policy | A parameterized rule set controlling required |
| Pack | proofs, weighting, risk scoring, settlement |
| | timing, rollback windows, and adapter |
| | selection. |
| Proof | A minimum-disclosure verification bundle |
| Bundle | comprising evidence digests, device |
| | attestations, optional physical/material |
| | challenge-response, role/institution |
| | attestations, and authorization signatures. |

### 2. System Overview and Technical Effects

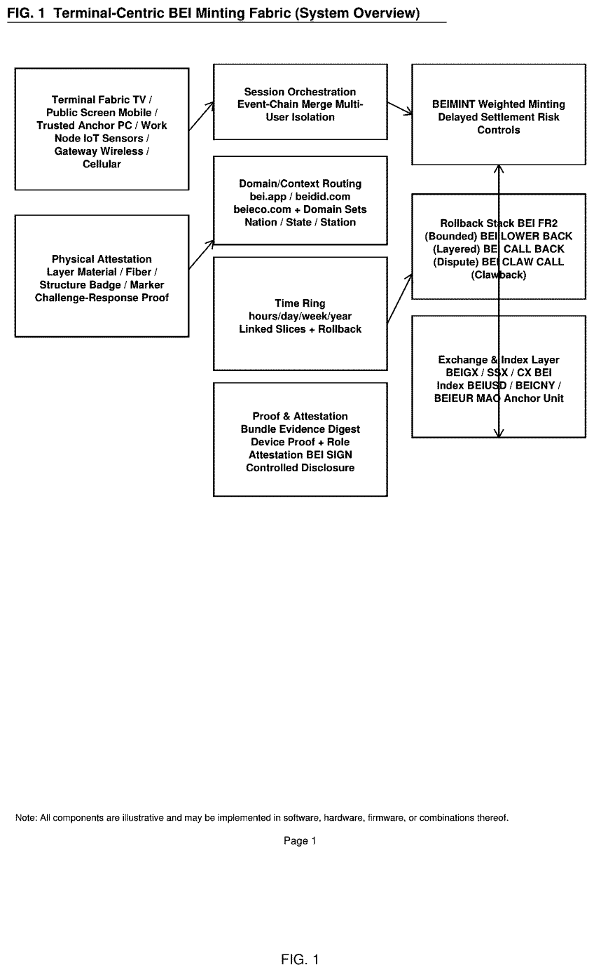

FIG. 1 depicts a terminal-centric applied computing system in which: (i) a public-screen terminal and a trusted personal terminal perform challenge-response binding; (ii) one or more domain basepoints route sessions and enforce domain-context policies; (iii) a deed-chain module validates authorization and produces a deed-chain reference (deed_ref) used as an executable access gate; (iv) a time-ring module computes validated time-slice coverage with anti-double-counting; (v) a proof-bundle module emits digest/commitment evidence under controlled disclosure; (vi) a minting module (BEIMINT) mints TIME CURRENCY and BEI CURRENCY under policy-pack risk controls and settlement windows; and (vii) a governance state machine supports dispute callback, bounded rollback, layered rollback, and clawback. An optional exchange/index/peg layer may support conversion, listing, and remittance without compromising bounded governance scope.

In non-limiting embodiments, the disclosed architecture yields technical effects including: (1) improved computer security and authorization integrity by gating minting and/or transfer on deed_ref validity bound to terminal attestations; (2) improved accounting correctness in multi-terminal environments by computing a coverage map over time_slice_id intervals to prevent double-counting; (3) improved privacy and reduced attack surface by transmitting proof bundles as digests/commitments with selective disclosure; (4) improved fault isolation and dispute remediation by limiting rollback/clawback to specific time slices and domain contexts; and (5) improved interoperability and scalability across heterogeneous terminals and networks by treating basepoints as routing and namespace anchors.

Population-Scale Root Basepoint and Instant Remittance (Non-Limiting). In a population-scale deployment, a root basepoint (e.g., ATMS.COM) and associated directories may provide discovery, onboarding, and policy distribution for large terminal populations, while each mint and transfer remains scoped to a basepoint/channel and time_slice_id. For remittance, a sender may transfer one or more mint-output records (directly or via an exchange interface), and a recipient may validate deed_ref, proof-bundle digests, and policy-pack risk constraints. When constraints are satisfied, settlement may be near-instant; otherwise, the transaction may remain pending within a delayed settlement window, while preserving bounded rollback/clawback capability and auditable lineage.

Examiner-Friendly Distinctions (Non-Limiting). Unlike generic blockchain tokens or purely financial recordkeeping, the embodiments and claims employ concrete data structures and control logic, including time-ring slice accounting (e.g., time_slice_id, coverage map, validated_duration), deed-gated authorization (e.g., deed_ref and deed-chain lineage), minimum-disclosure proof bundles (e.g., digests/commitments), and a governance state machine that can apply bounded rollback, layered rollback, and/or clawback to a defined scope. Accordingly, the disclosed system improves terminal-bound authorization, integrity of time/event accounting, and privacy-preserving verification in multi-terminal environments.

### 3. Domain Basepoints, Access Channels, and Deed Chains

A terminal is onboarded by binding it to one or more domain basepoints and access channels. A deed chain records authorization state transitions, including ownership, delegation, leasing, revocation, and time-bounded grants. The binding and deed-chain reference are mandatory pointers for minting and settlement, preventing minting outside authorized channels.

### 3.1 Deed Record (Non-Limiting Data Structure)

| Field | Description |
|---|---|
| deed_id | Identifier for the deed record (e.g., hash of |
| | contents). |
| grantor_id | Identifier of grantor (entity delegating rights). |
| grantee_id | Identifier of grantee (terminal, user, |
| | institution, or service). |
| basepoint_id | Bound domain basepoint. |
| channel_id | Bound access channel under the basepoint. |
| scope | Granted scope (e.g., bind, mint, settle, |
| | transfer/remit, attest) and limits; optional |
| | leasing, sublicensing, or assignment. |
| valid_from/valid_to | Validity window (time-bounded grants |
| | supported). |
| revocation_terms | Conditions for revocation or auto-expiration. |
| signature | Cryptographic signature of grantor (and |
| | optionally co-signers). |
| parent_deed_ref | Reference to previous deed (chain linkage). |
| audit_pointer | Pointer to audit log/proof bundle justifying |
| | issuance. |

Transferable Licensing Object (Non-Limiting). In embodiments, a deed record functions as a transferable licensing object that encodes a granular bundle of system capabilities for a basepoint/channel, including one or more of terminal binding, proof attestation, minting, settlement, remittance routing, exchange listing, or index/peg conversion. Transfer, leasing, sublicensing, or assignment may be represented as an append-only deed-chain update that changes a grantee_id and/or scope while preserving authorization lineage via parent_deed_ref and audit_pointer. The system enforces a deed_ref gate at execution time, such that minting, settlement, and remittance are permitted only when the deed_ref resolves to a currently valid deed record under the applicable policy pack. In non-limiting implementations, a deed_ref may be mapped to a tokenized right (non-fungible or semi-fungible) to support custody and transfer semantics while preserving revocation and bounded rollback under policy control. In non-limiting deployments, a deed registry interface may be hosted at a deed basepoint (e.g., beideed.com or BEIDEED.COM) to publish, query, and transact deed records.

### 3.2 Terminal-Basepoint Binding Record

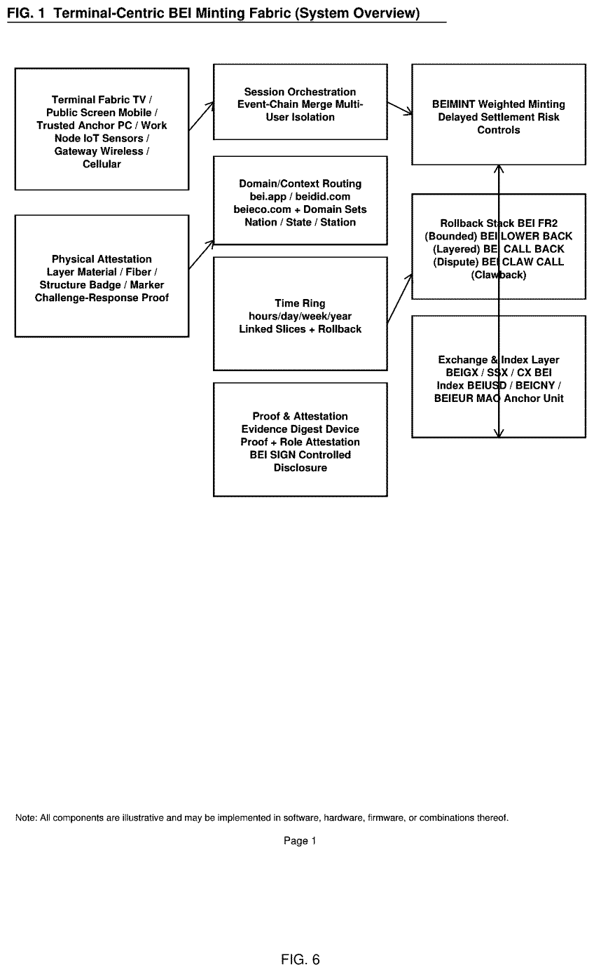

FIG. 6 illustrates a binding record that associates a terminal and a subject identity to a basepoint/channel under a deed chain. Binding may be established via a challenge-response puzzle displayed on a public-screen terminal and confirmed by a trusted personal terminal using BEI SIGN.

| Field | Description |
|---|---|
| terminal_id | Terminal identifier (public |
| | key/certificate/device fingerprint). |
| bei_id (BID) | Subject identity reference (BEI/DID/BEIDID |
| | variant). |
| basepoint_id | Domain basepoint (e.g., BEI.APP, |
| | BEIDID.COM, BEIECO.COM, and/or multi- |
| | system domain sets). |
| channel_id | Access channel (subdomain/alias/directory |
| | entry/token id). |
| deed_ref | Pointer to deed chain state authorizing the |
| | binding. |
| station_id | Station context (home, classroom, hospital, |
| | factory, store, etc.). |
| jurisdiction_id | Jurisdiction context (nation/state policy gate), |
| | if applicable. |
| policy_pack_id | Policy pack selected for the basepoint/channel |
| | context. |
| time_ring_anchor | Time-slice anchor for binding and audit (e.g., |
| | current hour slice). |
| binding_signature | Signature by trusted personal terminal |
| | authorizing the binding. |

### 4. Time Ring and Slice Accounting

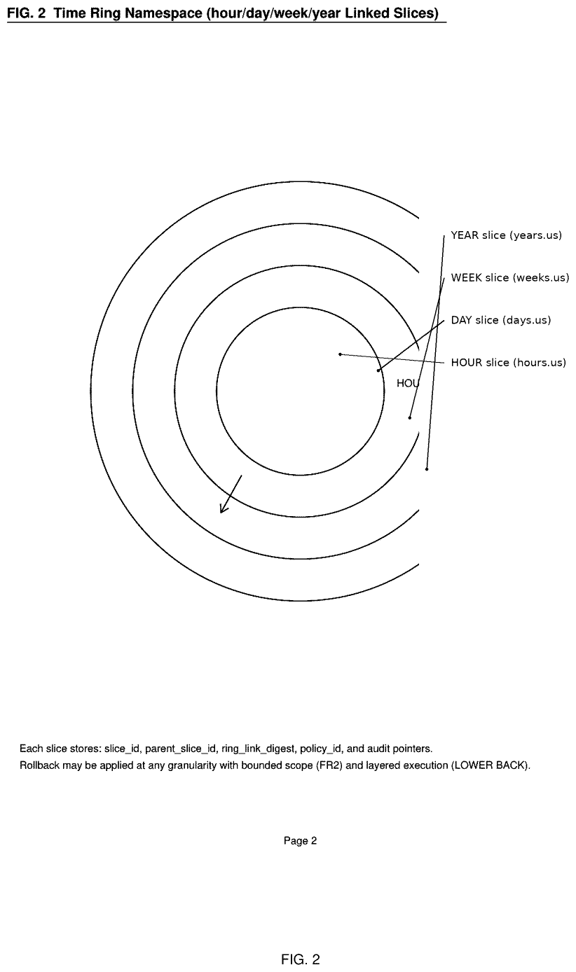

FIG. 2 illustrates a time ring with linked slices across multiple granularities. Each slice may store a slice identifier, parent slice identifier(s), link digests, policy references, and audit pointers. A key requirement is to avoid cross-terminal double counting of time within the same slice, even when multiple terminals are active.

### 4.1 Time-Slice Coverage Map (Anti-Double-Counting)

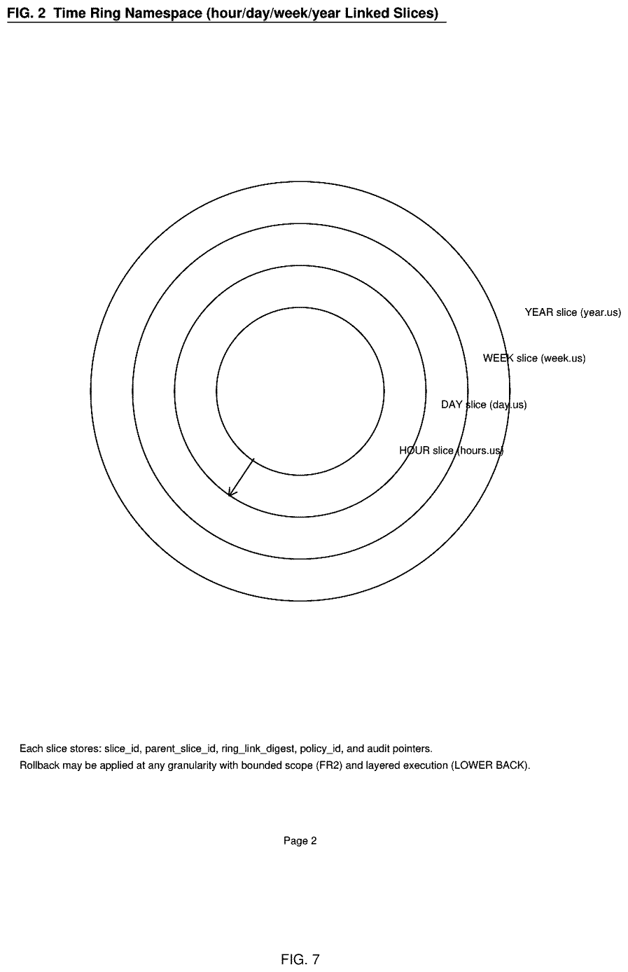

FIG. 7 illustrates a coverage map that unions activity intervals across terminals for a given (bei_id, basepoint_id, slice_id) key. In one embodiment, the system applies a focus-window rule where the trusted personal terminal provides authoritative focus intervals. Validated coverage is computed as a de-duplicated union of intervals, producing validated_duration_seconds and a coverage ratio.

| Field | Description |
|---|---|
| key = (bei_id, basepoint_id, slice_id) | Primary key for coverage |
| | map entries. |
| intervals[ ] | Observed activity intervals from |
| | one or more terminals. |
| focus_window | Authoritative interval(s) derived |
| | from trusted personal terminal, |
| | if present. |
| union_intervals[ ] | Merged union after overlap |
| | removal and de-duplication. |
| validated_duration_seconds | Total time counted for the |
| | slice after de-duplication. |
| coverage_ratio | validated_duration_seconds |
| | divided by slice length. |
| audit_pointer | Pointer to proof bundles/logs |
| | supporting the computed |
| | coverage. |

### 4.2 Denomination Mapping (Non-Limiting UI Labels)

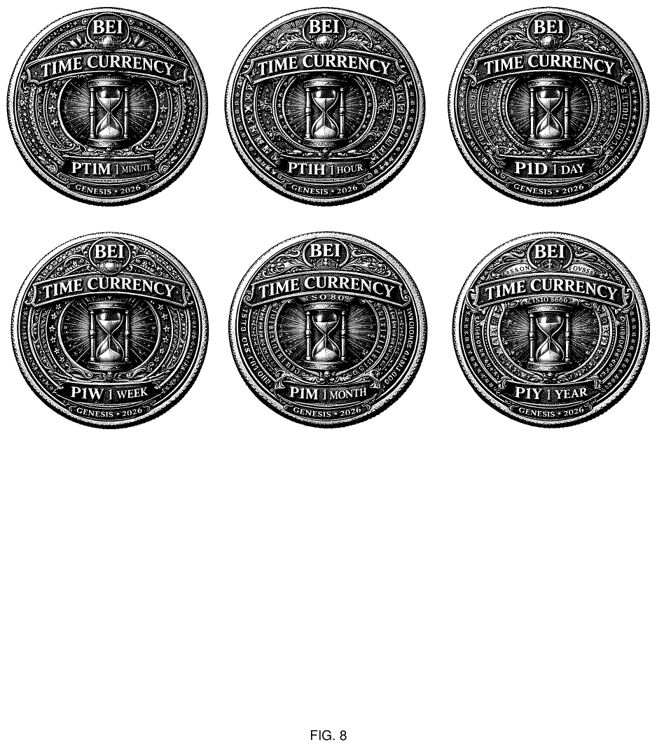

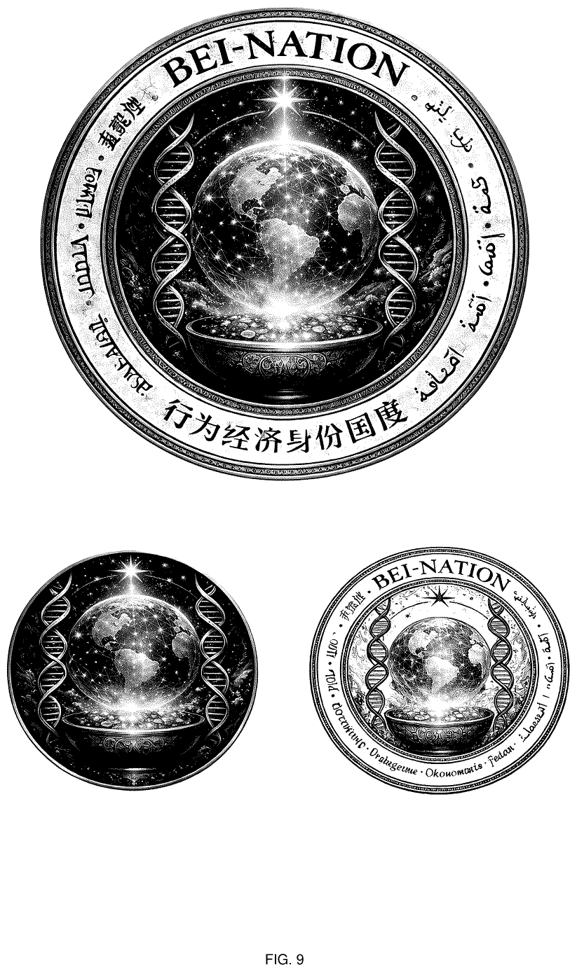

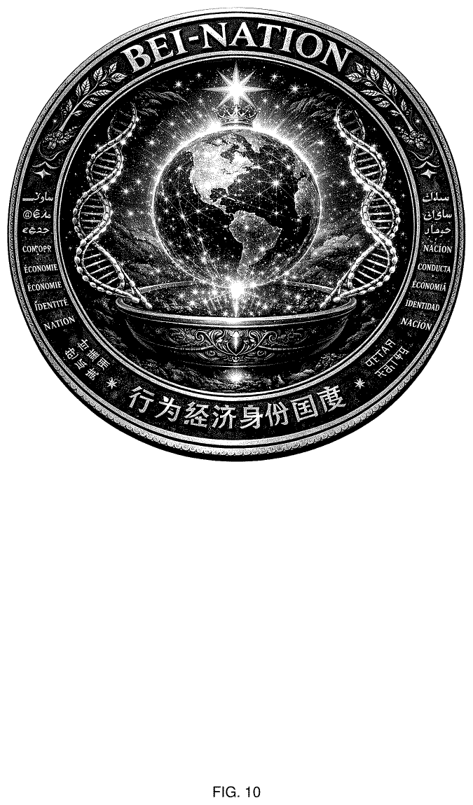

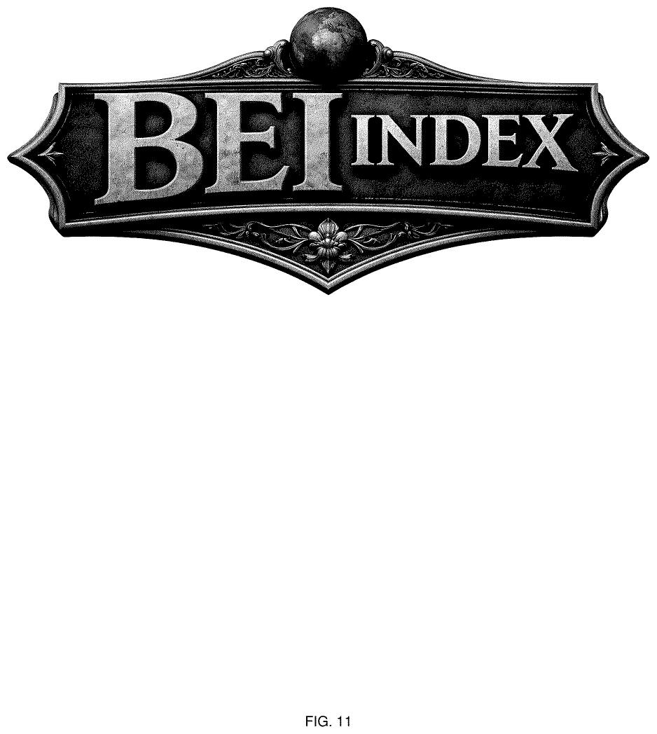

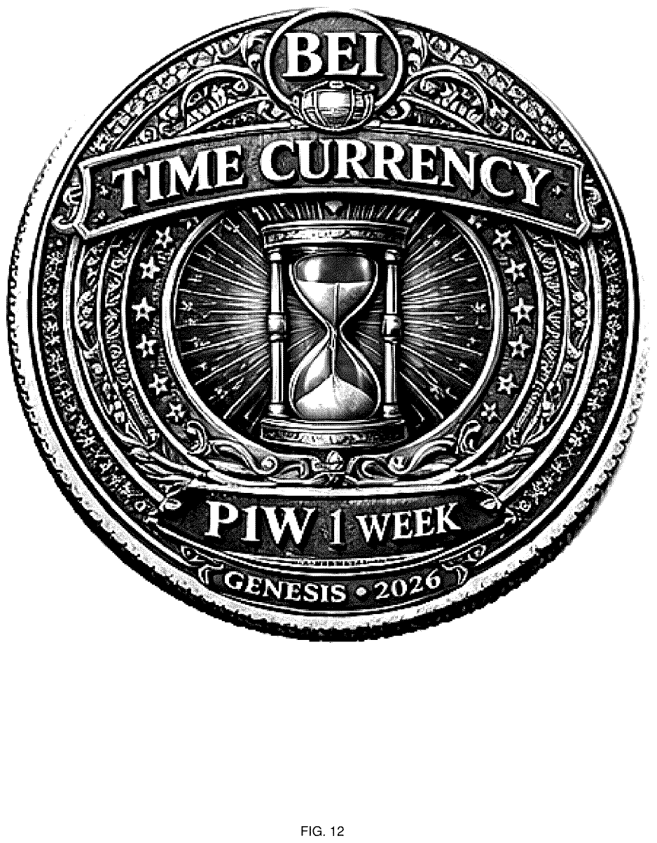

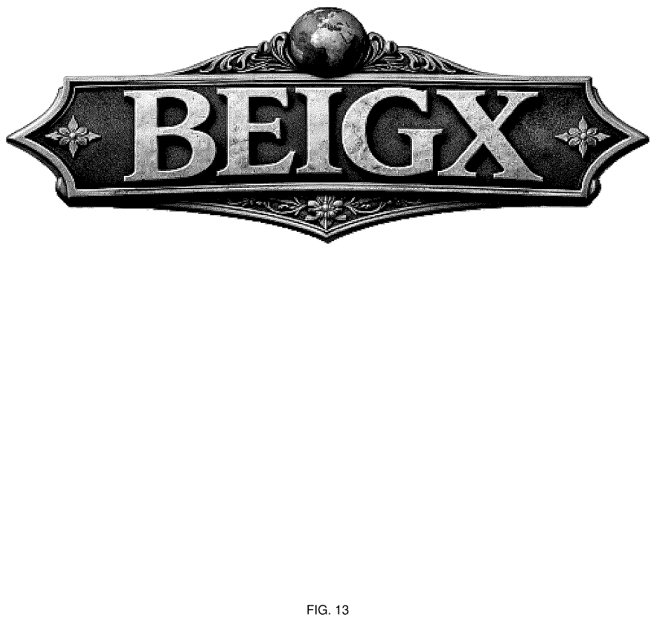

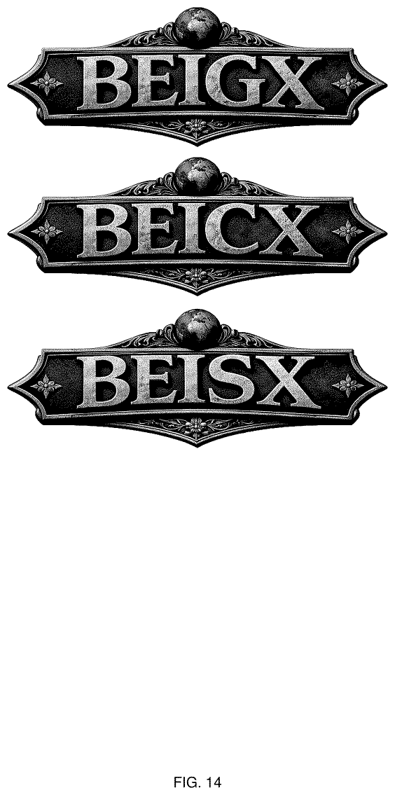

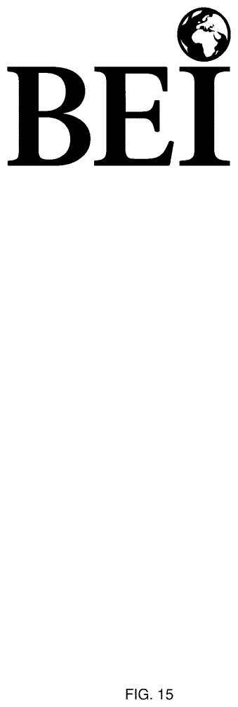

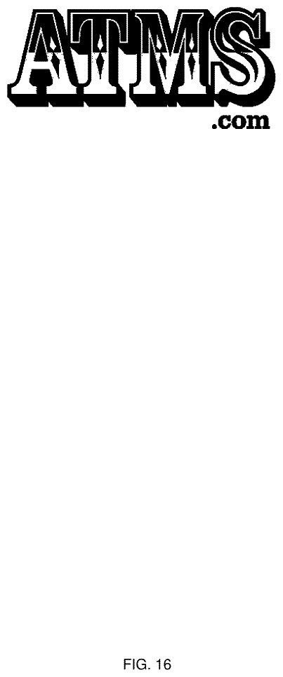

FIGS. 8-13 illustrate non-limiting renderings for time-denominated units (e.g., minute/hour/day/week/month/year slices) and may further include illustrative labels, plaques, emblems, or insignia (e.g., BEI Nation, BEI Index, and BEIGX), optionally including illustrative Genesis 2026 labeling. These renderings support denomination mapping and user-interface display and are illustrative only. In embodiments, the system mints units based on validated time-slice accounting.

| Label (Example) | Mapped Time Slice |
|---|---|
| PTIM | Minute slice unit (1 minute). |
| PTIH | Hour slice unit (1 hour). |
| PID | Day slice unit (1 day). |
| PIW | Week slice unit (1 week). |
| PIM | Month slice unit (1 month). |
| PIY | Year slice unit (1 year). |

### 5. Proof Bundle and Controlled Disclosure (BEI SIGN)

The proof bundle supports minimum-disclosure verification. Evidence may be stored as digests/commitments where possible, with policy-governed disclosure in disputes. The trusted personal terminal generates an authorization signature and may provide private input and focus-window intervals.

| Field | Description |
|---|---|
| proof_bundle_id | Identifier for bundle (e.g., hash). |
| session_id | Multi-terminal session identifier. |
| evidence_digest[ ] | Digests/commitments of evidence |
| | artifacts. |
| device_attestation[ ] | Signed terminal-origin records |
| | and/or secure execution proofs. |
| role_attestation[ ] | Non-limiting examples: |
| | teacher/student, doctor/patient, |
| | supplier/worker/consumer. |
| physical_attestation | Optional challenge-response based on |
| | badge/material/fiber/structure |
| | features. |
| authorization_signature | Signature from trusted personal |
| | terminal (BEI SIGN). |
| basepoint_id/channel_id/deed_ref | Mandatory context pointers for |
| | minting and audit. |
| slice_id(s) | Time-slice pointer(s) in the time ring. |
| risk_inputs | Signals used for risk scoring (e.g., |
| | repetition, conflicts, anomalies). |
| disclosure_policy_id | Policy governing what may be |
| | revealed in disputes. |

### 6. BEIMINT (BIMINT) Minting of TIME CURRENCY and BEI CURRENCY

BEIMINT mints TIME CURRENCY and BEI CURRENCY from validated mint inputs. Minting is policy-governed and includes risk scoring, delayed settlement windows, and audit pointers.

### 6.1 Mint Input Tuple and Mint Output Record

A mintable event must reference a mint input tuple that binds terminal provenance, domain context, deed authorization, and time-slice accounting. This prevents minting outside authorized channels and enables bounded rollback by slice and context.

| Field | Description |
|---|---|
| mint_input_tuple | (terminal_id, basepoint_id, channel_id, |
| | deed_ref, slice_id, proof_bundle_id). |
| time_currency_amount | Minted TIME CURRENCY units for the |
| | slice(s). |
| bei_currency_amount | Minted BEI CURRENCY units derived |
| | from behavior-weighted proofs. |
| policy_pack_id | Policy pack used to compute amounts |
| | and settlement windows. |
| risk_score | Computed risk score and applied |
| | penalty/holdback. |
| settlement_window | Delay period before final settlement. |
| state | Lifecycle state (e.g., MINT_PENDING, |
| | MINTED, SETTLED). |
| rollback_pointer | Pointers enabling dispute callback, |
| | bounded rollback, layered rollback, |
| | and clawback. |
| wallet_or_custody_pointer | Destination pointer for settled units |
| | (wallet/custody). |

### 6.2 Non-Limiting Computation Examples

In one non-limiting implementation, TIME CURRENCY for a slice is computed as:

TIME=base_units*granularity_factor*terminal_trust_weight*proof_strength_weight*risk_penalty,
where base_units is validated_duration_seconds divided by the slice length.

In one non-limiting implementation, BEI CURRENCY is computed as:
BEI=(TIME*event_type_coefficient*outcome_score*attestation_weight)*risk_penalty, or an equivalent function that derives BEI units directly from event-chain value features.

### 7. Governance: State Machine, Dispute Callback, Rollback, and Clawback

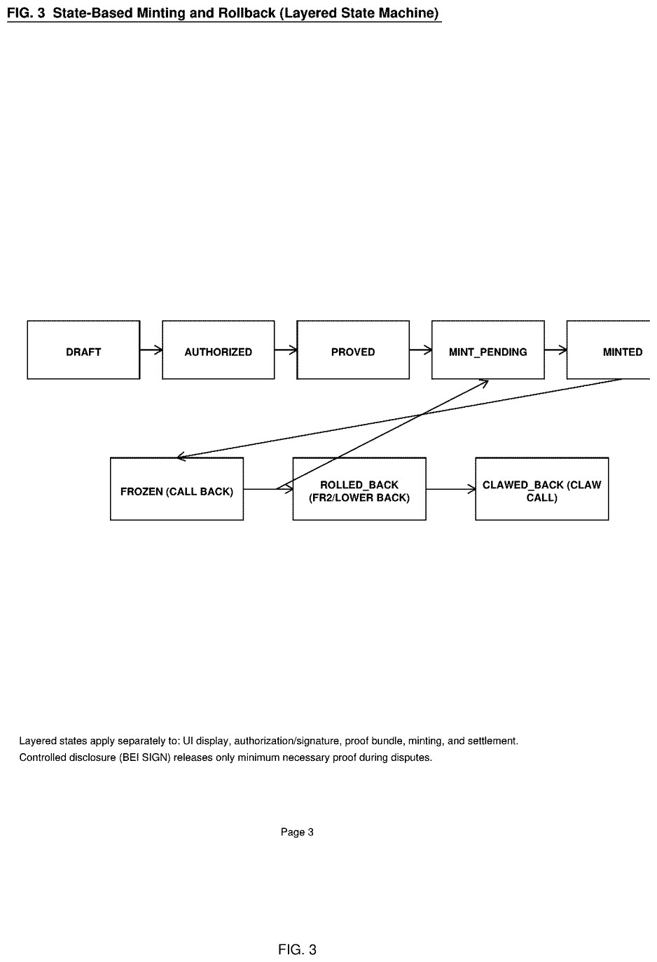

FIG. 3 illustrates a state-based lifecycle. Delayed settlement enables governance without destroying provenance. Rollback scope is bounded by time slice and domain context to control remediation blast radius.

| State | Description |
|---|---|
| DRAFT | Event chain captured but not yet authorized |
| | by trusted personal terminal. |
| AUTHORIZED | Authorization signature recorded; deed state |
| | updated if needed. |
| PROVED | Proof bundle formed and validated. |
| MINT_PENDING | Mint outputs computed and held during |
| | settlement window. |
| MINTED | Mint outputs finalized and recorded. |
| SETTLED | Outputs delivered to custody/wallet and |
| | eligible for exchange/conversion. |

Governance procedures include:
BEI CALL BACK: dispute callback to request additional minimum-disclosure proofs and resolve conflicts.
BEI FR2: bounded rollback limited by time slice, basepoint/channel, station, jurisdiction, or both.
BEI LOWER BACK: layered rollback across UI, authorization, proof, minting, and settlement layers.
BEI CLAW CALL: clawback/freeze/reclaim of minted units under policy conditions.

### 8, Policy Packs, Adapters, and Modular Licensing

Policy packs parameterize proofs, weights, risk controls, and settlement windows per domain basepoint/channel. Adapters map minted outputs into settlement outputs such as payments, service rights, quotas, or resource claims. This modularity enables licensing, transfer, and authorization of different capability slices to different counterparties (e.g., terminal binding, time-slice accounting, proof bundling, BEIMINT minting, rollback stack, and optional exchange/index/peg conversion).

### 9. Optional Exchange, Index, and Peg Conversion

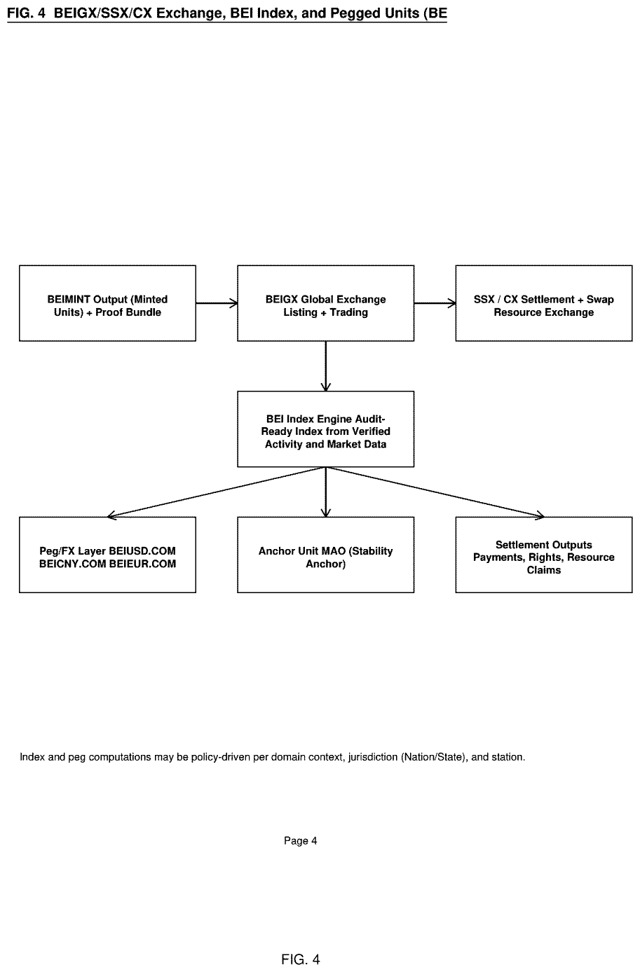

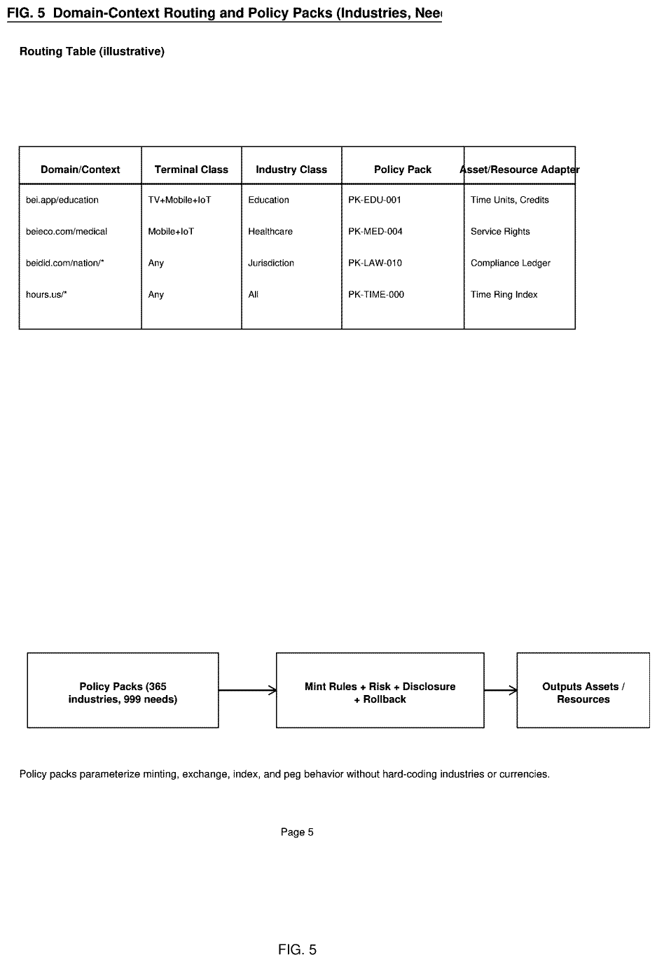

FIG. 4 illustrates optional interfaces for listing and conversion. TIME CURRENCY and/or BEI CURRENCY may be exchanged via BEIGX/SSX/CX interfaces, aggregated into an audit-ready BEI Index, and converted into pegged units (e.g., BEIUSD/BEICNY/BEIEUR) and/or an anchor unit for settlement outputs. These layers are optional and may be implemented independently from the core terminal-to-mint pipeline.

Instant/Low-Latency Transfer and Remittance (Non-Limiting). In embodiments, a mint-output record and/or a settled minted-unit record can be transferred to a recipient wallet pointer to perform remittance, including cross-basepoint and cross-jurisdiction transfers routed via a root basepoint (e.g., ATMS.COM). The transfer may be effected by (i) direct mint-output record transfer between terminals/wallet pointers, (ii) an exchange interface (e.g., BEIGX/BEISX/BEICX/SSX/CX), or (iii) a policy-defined clearing/settlement adapter. When policy-defined risk controls are satisfied, the system may commit settlement and enable near-instant remittance; otherwise, outputs may remain pending during a delayed-settlement window, subject to bounded rollback, layered rollback, and/or clawback within a policy-defined scope.

### 10. Non-Limiting Domain Sets and Deployment Examples

Non-limiting examples of basepoints include BEI.APP, BEIDID.COM, BEIBID.COM, BEIDEED.COM, BEIPEG.COM, BEIANCHOR.COM, BEIECO.COM, BEIGW.COM, BEIEDGE.COM, BEINODE.COM, BEIHOST.COM, BEIURL.COM, BEILOTS.COM, BEITVS.COM, HOURS.US, TIME.US, HOUR. US, DAY.US, WEEK.US, MONTH.US, YEAR. US, and a multi-system identifier estate comprising a plurality of unique domain-name anchors and/or top-level-domain (TLD) basepoints; functionally equivalent namespace identifiers may be used.

Additional non-limiting basepoint examples include BEIAUDIT.COM, BEIHELIX.COM, BEITVS.COM, BEIBASEPOINT.COM, BEIRINGS.COM, BEIURL.COM, and BEILOTS.COM. These identifiers are illustrative only and do not limit claim scope.

Non-limiting examples further include ATMS.COM as a root basepoint and gateway directory embodiment, beibid.com (or BEIBID.COM) as a BID identity-root basepoint and index embodiment, beideed.com (or BEIDEED.COM) as a deed-chain licensing and delegation registry basepoint, and beim.app (or BEIM.APP) as a mobile minting access channel and application embodiment, beipeg.com (or BEIPEG.COM) as an illustrative basepoint for pegged-unit (value-peg) conversion and anchor reference discovery, and BEIAnchor.com (or BEIANCHOR.COM) as an illustrative anchor-reference directory basepoint for reference-unit discovery and policy-controlled anchor mapping, each being functionally equivalent to other namespace anchors and signed directory identifiers.

Non-limiting examples further include beichain.app, beichain.org, and beichains.com as chain-namespace access channels and/or ledger-routing basepoints for distributed-ledger record anchoring, deed-chain reference resolution, and/or settlement discovery, functionally equivalent to other namespace anchors.

Non-limiting examples further include thebanks.app as an illustrative access channel and/or directory basepoint for bank-network discovery, multi-terminal onboarding, and/or policy-gated transfer routing, functionally equivalent to other namespace anchors.

### Cross-Industry Deployment Examples (Non-Limiting)

### Education/Training (In-Person or Remote).

A public-screen terminal in a classroom or remote session presents a session challenge bound to an education basepoint and channel (e.g., a course station). A trusted personal terminal of a student binds the session and signs an authorization signature. A deed_ref is validated under a policy pack (e.g., school eligibility rules). Activity intervals are collected from the public-screen terminal and the personal terminal, unioned and clipped to the relevant time_slice_id (minute/hour/day), and validated using the focus-window rule. A proof bundle stores digests/commitments for attendance, interaction state, and optional instructor attestation. TIME CURRENCY and/or BEI CURRENCY units are minted into a pending state, then settled after risk controls (e.g., anti-fraud thresholds) are satisfied.

### Healthcare/Clinic Check-In.

A clinic kiosk or public-screen terminal presents a challenge for a healthcare basepoint/channel (e.g., visit, lab, imaging). A patient's trusted personal terminal binds the session and supplies a privacy-preserving proof bundle (digests for consent, visit token, and optional location/biometric evidence). A role/institution attestation from a clinician terminal (or facility key) may be included. Anti-double-counting prevents overlapping sessions across devices (e.g., multiple kiosks) from inflating time coverage. Bounded rollback is scoped to the visit time_slice_id and facility channel to limit blast radius for disputes.

### Work Hours/Labor & Contract Timekeeping.

An employer or platform deploys a basepoint/channel for work authorization. A deed-chain record grants and can revoke work authorization for identities and terminals. A worker's personal terminal and one or more workplace terminals (e.g., gate reader, POS, workstation) generate interval records. Union-and-clip with focus-window dominance prevents double counting when multiple terminals are active concurrently. Minted outputs include a mint-output record referencing (identity, basepoint/channel, deed_ref, time_slice_id, proof-bundle reference, settlement state) to support audit and bounded rollback.

Advertising/Media Attention with Public-Screen Terminal.

A TV or public display presents a challenge for a media basepoint/channel and optionally emits a short-range token (QR/NFC/UWB/Bluetooth/ultrasound). A trusted personal terminal binds the session and submits minimum-disclosure evidence (e.g., interaction state digests, attention/engagement signals as commitments). The focus-window rule selects the dominant terminal interval to prevent inflated time coverage across simultaneous devices. Policy packs can enforce eligibility (e.g., region, age, frequency caps) and delayed settlement to mitigate replay or bot attacks.

### IoT/Utilities/Device-Verified Service.

A sensor/gateway terminal and a trusted personal terminal collaborate under a basepoint/channel (e.g., diagnostics, metering, maintenance). Device attestation from the gateway and optional physical-challenge attestation are included in the proof bundle, with raw sensor data protected by digests/commitments. Time-ring anchoring supports aggregation from minute to month/year slices. Policy packs may restrict minting to verified device classes or certified installers, and bounded rollback is limited to the affected time_slice_id and channel.

In embodiments, each terminal session is routed to a selected basepoint and access channel (e.g., a subdomain, alias, directory entry, or signed channel token) under the basepoint, and minting requires a deed-chain reference that authorizes the subject and one or more terminals for the selected basepoint/channel context; the foregoing domain-name examples are illustrative only and do not limit scope.

### 11. Security and Privacy

Security includes cryptographic signatures for authorization and attestations, integrity-protected logs, and optional secure execution environments. Privacy includes digest-based evidence and policy-governed disclosure in disputes, enabling verifiability without pervasive raw-data retention.

### 12. Variations

Embodiments may be centralized, distributed, or hybrid. Physical/material attestations may be omitted or replaced with other sensor proofs. Index and peg conversion may be omitted. Any module may be licensed, transferred, or implemented independently, provided the disclosed interfaces are respected.

### 12.7 Mobile Application Demo Embodiment (BEIM.APP-Real-Time Personal Minting and Instant Transfer)

In a mobile-centric embodiment, the system is deployed via BEIM.APP as an access channel under a root basepoint (e.g., ATMS.COM or BEIBID.COM). The trusted personal terminal (smartphone) serves as the primary interface, demonstrating:
challenge-response onboarding with public-screen or gateway binding;
live Time Ring visualization and validated time-slice coverage computation via a focus-window rule and anti-double-counting;
real-time BEIMINT casting of TIME CURRENCY and BEI CURRENCY units with policy-pack controlled weighting and risk controls;
wallet display of minted units and zero/low-fee instant transfer/remittance via an exchange interface and/or direct mint-output record transfer;
privacy preservation through digest/commitment-only proof bundles and governance notifications for bounded rollback, layered rollback, and/or clawback.

This embodiment enables deployment on standard smartphones, supporting personal minting, BEI Index viewing, pegged conversion, and seamless money transfer without intermediaries, scalable to global populations.

### 13. Specific Embodiment: Verifiable Remote Learning & Anti-Fraud System

In a specific embodiment applicable to the educational technology sector, the system is configured to validate remote learning hours and prevent attendance fraud (“anti-cheat”).

Hardware Binding: A public-screen terminal (e.g., a student's laptop playing a lecture) displays a dynamic challenge code. A trusted personal terminal (e.g., the student's smartphone with a secure key) scans or handshakes with this code. This action generates a binding record in the deed chain, cryptographically locking the student's BEI identity to the specific course session (access channel).

Anti-Double-Counting with Focus Window: During the session, the time-ring module tracks minute slices. The anti-double-counting module applies a “Focus-Window Rule.” If the trusted personal terminal detects the user leaving the room or switching context, the focus window closes. If the user attempts to play the same course on a second device simultaneously, the system computes the union of intervals and clips overlapping durations, ensuring only one valid second of “TIME CURRENCY” is minted for every physical second elapsed, regardless of the number of screens active.

Privacy-Preserving Proof Bundle: Upon session completion, raw video data is not required to be uploaded. Instead, a proof bundle is formed containing only cryptographic digests of the session activity and the smartphone's sensor attestations. This bundle is submitted to the BEIMINT engine.

Minting and Settlement: The BEIMINT engine mints TIME CURRENCY (representing raw attendance hours) and BEI CURRENCY (weighted by quiz interactions). These outputs are held in a pending state during a settlement window. If no dispute callback is triggered (e.g., by an anomaly detection algorithm), the units settle into the student's wallet, serving as immutable proof of academic credit.

### 14. Technical Improvements and Examiner-Facing Clarifications (Non-Limiting)

To assist examination and to clarify technical character, the disclosed embodiments are implemented in, and improve, computer and network operations.

Terminal binding is rooted in concrete device interaction: a public-screen terminal emits a session challenge and a trusted personal terminal generates an authorization signature bound to (BEI/BID, basepoint, channel) and validated by a deed_ref. This constrains minting to authorized basepoint/channel contexts and reduces unauthorized session injection and replay.

Time-ring anchoring and anti-double-counting processing provide a specific multi-terminal time accounting algorithm that computes validated time-slice coverage by unioning activity interval records, clipping to time-slice boundaries, and applying a focus-window rule to prevent concurrent multi-terminal overcount. This improves integrity of time accounting and reduces erroneous minting outputs.

Proof bundling improves network and storage efficiency and privacy by representing evidence as cryptographic digests and/or commitments under controlled disclosure policies rather than transmitting or storing raw content. Policy packs and delayed settlement add risk controls that operate as technical gating and state control within the minting pipeline.

Governance procedures including dispute callback, bounded rollback scoped to (time_slice_id, basepoint/channel), layered rollback, and clawback provide controlled remediation for digitally issued units. The bounded scope limits rollback blast radius and preserves auditability across the remaining ledger.

### 15. Non-Limiting Distinctions from Conventional Approaches (Non-Limiting)

Non-limiting distinctions from conventional approaches include the following combinations, which operate together to produce the technical effects described herein:
(i) Shared-screen sessions are bound to a trusted personal terminal signature under an auditable deed-chain authorization reference (deed_ref) tied to a domain basepoint and access channel; conventional time-tracking and reward systems generally lack this cryptographically auditable authorization gating for mint eligibility.
(ii) Anti-double-counting is performed across two or more terminals using time-slice anchoring, union-and-clip interval processing, and a focus-window rule; conventional single-terminal proofs and generic time-spent counters do not address cross-terminal concurrency and therefore remain vulnerable to multi-device inflation.
(iii) Proof bundles use minimum disclosure with digests/commitments and policy-governed disclosure, which differs from approaches that require uploading raw personal content or that cannot satisfy privacy/compliance constraints.
(iv) Governance includes bounded rollback constrained to (time_slice_id, basepoint/channel) and optional layered rollback and clawback, providing a remediation capability not present in conventional immutable-only issuance pipelines or in simple reversible databases lacking ledger-grade auditability.

### 16. Enablement Notes and Example Processing (Non-Limiting)

### Enablement and Example Processing (Non-Limiting)

Anti-double-counting example: For a key K=(subject_id, basepoint/channel, time_slice_id), represent each activity interval as (start_ts, end_ts, terminal_id, trust_weight, interaction_state). Normalize intervals to the slice boundary, sort by start_ts, union overlapping intervals, then apply a focus-window rule on overlaps to select dominant intervals based on trust_weight and/or interaction_state. Clip the resulting coverage to the slice boundary and compute duration_seconds to determine TIME CURRENCY units denominated by the time_slice_id.

Proof bundle example fields: (proof_bundle_id, digest_list, commitment_list, device attestations, role/institution attestations, optional challenge-response attestations, authorization_signature, deed_ref, time_slice_id, policy_pack_id, risk_score, proof_strength_score). Mint output record example fields: (mint_output_id, subject_id, basepoint/channel, deed_ref, time_slice_id, proof_bundle_id, time_units, bei_units, settlement_state, settlement_window_id, audit_pointer).

### Appendix to Specification

An appendix to this specification, entitled “APPENDIX TO SPECIFICATION-RELATED BEI×BEI GALAXY×ATMS×DOMAIN-BASED ECOSYSTEM FILINGS,” is filed herewith and forms part of this specification. The appendix provides a consolidated list of approximately three hundred eighty (380) related U.S. and international patent applications filed by the present inventor and commonly owned entities for technical background and ecosystem context, to the extent not inconsistent with the present disclosure. The applications listed in the appendix may have various prosecution statuses, including pending, allowed, issued, or abandoned.

In addition, in some embodiments, a further appendix may be filed in connection with this application or a related application, entitled “APPENDIX-DOMAIN-NAME PORTFOLIO FOR BEI×BEI GALAXY×ATMS ECOSYSTEM.” Such an appendix, if filed, may set forth a portfolio list of approximately two thousand eight hundred (2,800) unique, system-level domain names associated with the BEI, BEI Galaxy, ATMS, and related ecosystems. These domain names are described herein as ecosystem components that can function as namespaces and routing endpoints for BEI identities and YueNames, digital land parcels and service nodes within a multi-layer domain fabric, and anchors for material, resource, and asset flows represented in time-ledger and tokenization mechanisms described in this specification.

Except where an individual application is expressly identified in the Application Data Sheet (ADS) and/or in the Cross-Reference to Related Applications section as a priority or domestic benefit application, the applications, publications, domain names, and materials listed in any appendix are not relied upon for priority, domestic benefit, or foreign priority in the present application. Identification of such applications, publications, or domain names in any appendix is not an admission that any such document or material constitutes prior art to the present application. The appendix is provided for technical background and ecosystem context and does not include essential material necessary to satisfy the written description, enablement, or definiteness requirements of 35 U.S.C. § 112. Any incorporation by reference herein is intended only for non-essential material and only to the extent permitted by 37 C.F.R. § 1.57

1. A terminal-centric system for minting TIME CURRENCY and BEI CURRENCY, comprising:
(a) a public-screen terminal configured to present a session challenge associated with a domain basepoint and an access channel;
(b) a trusted personal terminal configured to establish a session binding with the public-screen terminal responsive to the session challenge and to generate an authorization signature bound to (i) a subject identity (BEI/BID), (ii) the domain basepoint, and (iii) the access channel;
(c) a deed-chain module configured to validate, issue, update, revoke, and/or expire a deed-chain record authorizing the subject identity and at least one terminal for the domain basepoint and the access channel, and to generate a deed-chain reference (deed_ref);
(d) a time-ring module configured to maintain a hierarchical time-slice structure comprising minute, hour, day, week, month, and year time slices and to anchor a session record to at least one time_slice_id in the hierarchical time-slice structure;
(e) an anti-double-counting module configured to compute, for the anchored time_slice_id, a validated time-slice coverage for the subject identity by: (i) collecting activity interval records from two or more terminals associated with the session record, (ii) computing a union of the activity interval records and clipping the union to boundaries of the anchored time_slice_id, and (iii) applying a focus-window rule selecting, for overlapping activity interval records, a dominant interval based on at least one of terminal trust level or interaction state, thereby preventing double counting of concurrent multi-terminal activity;
(f) a proof-bundle module configured to generate a proof bundle comprising (i) cryptographic digests and/or commitments representing captured terminal evidence without requiring disclosure of underlying raw data, (ii) the authorization signature, (iii) the deed_ref, and (iv) the time_slice_id;
(g) a minting module (BEIMINT/BIMIT) configured to mint a minted output comprising:
(i) TIME CURRENCY units denominated by the time_slice_id based on the validated time-slice coverage, and (ii) BEI CURRENCY units derived from behavior-weighted proofs based on at least the proof bundle and one or more outcome attestations;
(h) a policy-pack module configured to apply one or more policy packs defining minting eligibility and risk controls for the domain basepoint and the access channel; and
(i) a governance module configured to support at least one of dispute callback, bounded rollback limited to a specified scope of (time_slice_id, basepoint/channel), layered rollback, or clawback for the minted output,
wherein minting by the minting module is permitted only when the deed_ref is valid under the policy pack for the domain basepoint and the access channel.

2. The system of claim 1, wherein the domain basepoint comprises a domain-name anchor, a top-level-domain-scoped basepoint, a multi-system namespace identifier, and/or a functionally equivalent signed directory anchor, and wherein the access channel comprises at least one of a subdomain, alias, directory entry, path identifier, or signed channel token. In non-limiting embodiments, the domain basepoint comprises ATMS.COM and/or BEIBID.COM and the access channel comprises a mobile application access channel (BEIM.APP).

3. The system of claim 1, wherein the deed-chain record comprises at least one of a grant, delegation, lease, sublicense, assignment, revocation, expiration, or transfer record, and includes a signature of an authorizing party and an audit pointer enabling verification of authorization lineage.

4. The system of claim 1, wherein the time-ring module stores for each time_slice_id a parent-slice identifier, a link digest, a policy identifier, and an audit pointer, thereby enabling aggregation across minute-to-year granularities while preserving per-slice auditability.

5. The system of claim 1, wherein the anti-double-counting module stores a time-slice coverage map in memory keyed by at least (subject identity, time_slice_id, basepoint/channel) and prevents double counting across terminals by rejecting overlapping intervals outside the selected focus window.

6. The system of claim 1, wherein the proof bundle further comprises at least one of device attestation, role/institution attestation, material or physical-challenge attestation, a risk score input, or a proof-strength score, and wherein the proof bundle is configured for minimum disclosure by storing only digests and/or commitments for protected data.

7. The system of claim 1, wherein the governance module enforces a delayed-settlement window during which the minted output is maintained in a pending state prior to final settlement, and wherein bounded rollback is limited to reversing only those minted units referencing the specified time_slice_id and basepoint/channel scope.

8. A computer-implemented method for terminal-centric minting of TIME CURRENCY and BEI CURRENCY, comprising:
(a) presenting, by a public-screen terminal, a session challenge associated with a domain basepoint and an access channel;
(b) establishing, by a trusted personal terminal responsive to the session challenge, a session binding with the public-screen terminal and generating an authorization signature bound to a subject identity (BEI/BID), the domain basepoint, and the access channel;
(c) validating and/or issuing a deed-chain record authorizing the subject identity and at least one terminal for the domain basepoint and the access channel, and generating a deed-chain reference (deed_ref);
(d) anchoring a session record to a time_slice_id in a hierarchical time-ring structure comprising minute, hour, day, week, month, and year time slices;
(e) computing a validated time-slice coverage for the time_slice_id by collecting activity interval records from two or more terminals, unioning the activity interval records, clipping the union to boundaries of the time_slice_id, and applying a focus-window rule to prevent double counting of concurrent multi-terminal activity;
(f) generating a proof bundle comprising cryptographic digests and/or commitments representing captured terminal evidence without requiring disclosure of underlying raw data, and further comprising the authorization signature, the deed_ref, and the time_slice_id;
(g) applying a policy pack defining minting eligibility and risk controls for the domain basepoint and the access channel;
(h) minting, by a BEIMINT/BIMIT minting module, TIME CURRENCY units denominated by the time_slice_id based on the validated time-slice coverage and minting BEI CURRENCY units derived from behavior-weighted proofs based on at least the proof bundle and one or more outcome attestations; and
(i) supporting, by a governance module, at least one of dispute callback, bounded rollback limited to a scope of (time_slice_id, basepoint/channel), layered rollback, or clawback for minted outputs,
wherein minting is permitted only when the deed_ref is valid under the policy pack for the domain basepoint and the access channel.

9. The method of claim 8, wherein presenting the session challenge comprises presenting at least one of a QR code, near-field signal, ultra-wideband (UWB) signal, Bluetooth signal, or ultrasound token, and wherein generating the authorization signature comprises signing, by the trusted personal terminal, a session binding record associated with the session challenge.

10. The method of claim 8, wherein generating the deed_ref comprises verifying a chain of authorization records including at least one of grant, delegation, lease, sublicense, assignment, revocation, expiration, or transfer, and rejecting minting when the deed_ref is absent, expired, revoked, or outside a policy-defined scope.

11. The method of claim 8, further comprising storing, for each minted output, a mint-output record comprising at least (subject identity, basepoint/channel, deed_ref, time_slice_id, proof-bundle reference, settlement state) to enable audit and bounded rollback.

12. The method of claim 8, wherein applying the focus-window rule comprises selecting a dominant interval based on at least one of (i) a terminal trust weight assigned to the trusted personal terminal, (ii) an interaction-state indicator, or (iii) an active-focus indicator, and excluding overlapping intervals from non-dominant terminals for time accounting.

13. The method of claim 8, wherein minting comprises computing at least one of a risk score or a proof-strength score and applying a policy-defined penalty or weighting to at least one of TIME CURRENCY or BEI CURRENCY prior to settlement, and maintaining minted outputs in a pending state during a delayed-settlement window.

14. The method of claim 8, further comprising listing at least one of TIME CURRENCY units or BEI CURRENCY units through an exchange interface, generating an auditable BEI index from verified activity and/or settlement records, computing a conversion into pegged units using the BEI index under a policy-defined conversion rule, and transferring, responsive to the policy pack and a valid deed_ref, at least one mint-output record and/or settled minted-unit record to a recipient wallet pointer to perform remittance, optionally via an exchange interface.

15. A non-transitory computer-readable medium storing instructions that, when executed by one or more processors, cause performance of operations for terminal-centric minting of TIME CURRENCY and BEI CURRENCY, the operations comprising:
(a) receiving or generating a session challenge associated with a domain basepoint and an access channel for a public-screen terminal;
(b) generating, by a trusted personal terminal, an authorization signature bound to a subject identity (BEI/BID), the domain basepoint, and the access channel;
(c) validating and/or issuing a deed-chain record authorizing the subject identity and at least one terminal for the domain basepoint and the access channel and generating a deed_ref;
(d) anchoring a session record to a time_slice_id in a hierarchical time-ring structure comprising minute, hour, day, week, month, and year time slices;
(e) computing a validated time-slice coverage for the time_slice_id using anti-double-counting;
(f) generating a proof bundle comprising digests and/or commitments representing captured evidence without requiring disclosure of underlying raw data, and further comprising the authorization signature, the deed_ref, and the time_slice_id;
(g) applying a policy pack defining minting eligibility and risk controls;
(h) minting TIME CURRENCY units denominated by the time_slice_id and minting BEI CURRENCY units derived from behavior-weighted proofs; and
(i) enforcing at least one governance action comprising dispute callback, bounded rollback limited to (time_slice_id, basepoint/channel), layered rollback, or clawback,
wherein minting is permitted only when the deed_ref is valid under the policy pack for the domain basepoint and the access channel.

16. The non-transitory computer-readable medium of claim 15, wherein computing the validated time-slice coverage comprises collecting activity interval records from multiple terminals, unioning the activity interval records, clipping the union to boundaries of the time_slice_id, and applying a focus-window rule to exclude overlapping intervals from non-dominant terminals.

17. The non-transitory computer-readable medium of claim 15, wherein generating the proof bundle comprises storing only cryptographic digests and/or commitments for protected data and includes at least one of device attestation, role/institution attestation, or physical-challenge attestation.

18. The non-transitory computer-readable medium of claim 15, wherein enforcing the governance action comprises limiting rollback to minted outputs that reference both the time_slice_id and the basepoint/channel scope, thereby bounding a rollback blast radius.

19. The non-transitory computer-readable medium of claim 15, wherein the operations further comprise maintaining a delayed-settlement window, and finalizing settlement only after policy-defined risk controls are satisfied, and, upon satisfaction of the policy-defined risk controls, committing settlement and enabling near-instant transfer/remittance of at least one mint-output record and/or settled minted-unit record via at least one of direct record transfer or an exchange interface.

20. The non-transitory computer-readable medium of claim 15, wherein the operations further comprise generating a mint-output record comprising at least (subject identity, basepoint/channel, deed_ref, time_slice_id, proof-bundle reference, settlement state) and selectively enabling or disabling minting features via policy packs on a per-basepoint or per-channel basis for modular deployment and licensing.
